(19) United States
(12) Patent Application Publication
(10) Pub. No.: US 2015/0093674 A1
(43) Pub. Date: Apr. 2, 2015

(54) FUEL CELL STACK AND SEPARATOR

(71) Applicant: BROTHER KOGYO KABUSHIKI KAISHA, Nagoya-shi (JP)

(72) Inventor: Atsuki Ikoma, Okazaki-shi (JP)

(21) Appl. No.: 14/500,148

(22) Filed: Sep. 29, 2014

(30) Foreign Application Priority Data
Sep. 30, 2013 (JP) 2013-206000
Apr. 25, 2014 (JP) 2014-091309

(51) Int. Cl. H01M 8/02; H01M 8/24

(52) U.S. Cl. CPC H01M 8/0254; H01M 8/0256; H01M 8/2465
USPC 429/457; 429/514

(57) ABSTRACT

A separator of planar shape includes a plurality of grooves which are formed in a first surface of the separator serving as one surface facing a membrane electrode assembly and which extend along a first direction parallel to the first surface. The separator includes a protrusion formed in the first surface and enclosing a first hole, a second hole, and the plurality of grooves. The separator includes a cutout part located between two third holes adjacent to each other and formed by the one outer edge part of the separator approaching the protrusion and the plurality of grooves in a second direction. A collecting electrode plate includes: a cutout part formed at a position corresponding to the cutout part of the separator; and a terminal part extending from the cutout part of the collecting electrode plate toward the second direction.

### CROSS-REFERENCE TO RELATED APPLICATIONS

This non-provisional application claims priority under 35 U.S.C.§119(a) on Patent Application No. 2013-206000 filed in Japan on Sep. 30, 2013 and Patent Application No. 2014-091309 filed in Japan on Apr. 25, 2014, the entire contents of which are hereby incorporated by reference.

### TECHNICAL FIELD

The present disclosure relates to a fuel cell stack and a separator in which depression and protrusion in the outer shape are allowed to be reduced.

### BACKGROUND

As one of fuel cells, a fuel cell employing a solid polyelectrolyte membrane having hydrogen ion permeability is known. In general, the fuel cell includes a fuel cell stack constructed from a plurality of stacked cells. The cell includes a membrane electrode assembly, a gasket, and a separator. The cell is constructed when both faces of the membrane electrode assembly are pinched by a pair of separators respectively through a gasket in between. The membrane electrode assembly includes a solid polyelectrolyte membrane, a cathode electrode, and an anode electrode. The cathode electrode is provided on one surface of the solid polyelectrolyte membrane. The anode electrode is provided on the other surface of the solid polyelectrolyte membrane. Each of the cathode electrode and the anode electrode includes a catalyst layer and a gas diffusion layer.

The fuel cell stack includes a collecting electrode plate for extracting generated electricity. For example, in a fuel cell stack known to the public, a configuration is disclosed that a cutout part is provided in a center part in the longitudinal direction of the rectangular separator and then a tie rod, a collecting electrode plate, and a voltage measurement terminal are provided in the cutout part of the stack part constructed from a plurality of separators. The cutout part is formed on both sides in the shorter-side direction of the separator along the longitudinal direction of the separator.

### SUMMARY

An aspect of the present disclosure is a fuel cell stack comprising: a membrane electrode assembly of planar shape; a separator of planar shape provided in one surface of the membrane electrode assembly, the separator being provided with a plurality of grooves formed in a first surface of the separator which is one surface of the separator facing the membrane electrode assembly and extending along a first direction parallel to the first surface, with a protrusion formed in the first surface and enclosing a first hole formed between one outer edge part of the separator along the first direction and the plurality of grooves, a second hole formed between the one outer edge part of the separator and the plurality of grooves and being separated from the first hole in the first direction, and the plurality of grooves, and with a cutout part which is formed between two third holes adjacent to each other formed between the first hole and the second hole in the first direction and between the protrusion plus the plurality of grooves and the one outer edge part of the separator in a second direction perpendicular to the first direction and parallel to the first surface and in which the one outer edge part of the separator approaches the protrusion and the plurality of grooves in the second direction; and a collecting electrode plate in which a through hole is formed at a position corresponding to each of the first hole, the second hole, and the two third holes and which is provided with a cutout part formed at a position corresponding to the cutout part of the separator and with a terminal part extending from the cutout part of the collecting electrode plate toward the second direction.

Another aspect of the present disclosure is a separator of planar shape provided with a plurality of grooves formed in a first surface of the separator which is one surface of the separator facing the membrane electrode assembly and extending along a first direction parallel to the first surface, with a protrusion formed in the first surface and enclosing a first hole formed between one outer edge part of the separator along the first direction and the plurality of grooves, a second hole formed between the one outer edge part of the separator and the plurality of grooves and being separated from the first hole in the first direction, and the plurality of grooves, and with a cutout part which is formed between two third holes adjacent to each other formed between the first hole and the second hole in the first direction and between the protrusion plus the plurality of grooves and the one outer edge part of the separator in a second direction perpendicular to the first direction and parallel to the first surface and in which the one outer edge part of the separator approaches the protrusion and the plurality of grooves in the second direction.

The above and further objects and features will more fully be apparent from the following detailed description of preferred embodiments with reference to accompanying drawings.

### BRIEF DESCRIPTION OF THE SEVERAL VIEWS OF THE DRAWINGS

FIG. 1A is a rear view of a fuel cell stack.

FIG. 1B is a plan view of a fuel cell stack.

FIG. 1C is a front view of a fuel cell stack.

FIG. 2A is a schematic diagram illustrating a first surface of a separator.

FIG. 2B is a schematic diagram illustrating a second surface of a separator.

FIG. 3 is a schematic diagram illustrating a collecting electrode plate.

FIG. 4 is a schematic diagram illustrating a gasket.

FIG. 5 is a schematic sectional view illustrating a configuration of a cell.

FIG. 6 is an enlarged view of part A of FIG. 1C.

### DETAILED DESCRIPTION

The fuel cell employing a solid polyelectrolyte membrane has a special feature that it does not take a long time before starting of power generation. Thus, application to various devices such as a home-use cogeneration system, an automobile, and a mobile device is anticipated. When mounting onto such various devices is taken into consideration, for the purpose of easiness in handling such as accommodation and installation, it is preferable that the solid polymer fuel cell has an outer shape whose depression and protrusion are reduced as much as allowed.

However, the fuel cell stack known to the public has a configuration that a pair of up and down tie plates are attached to both sides of the stack part and these tie plates are linked by four tie rods. The outer packaging employing tie plates and tie rods has caused a complicated concave-convex shape in the outer shape of the entire fuel cell stack.

In order to reduce depression and protrusion in the outer shape of the entire fuel cell stack, for example, an approach may be employed that the tie rods are arranged in the inside of the fuel cell stack. However, in the fuel cell stack known to the public, the cutout part formed in the separator is formed large along the longitudinal direction of the separator in order that the tie rods, the collecting electrode plate, and the voltage measurement terminal are arranged. Then, a fuel gas inlet and a fuel gas outlet are adjacent respectively to one end and the other end in the longitudinal direction of the cutout part formed on one side in the shorter-side direction of the separator. Further, a cooling water inlet and a cooling water outlet are adjacent respectively to one end and the other end in the longitudinal direction of the cutout part formed on the other side in the shorter-side direction of the separator. In the fuel cell stack known to the public, a configuration is not disclosed that the tie rods are arranged in the inside of the separator in a manner of avoiding the fuel gas inlet, the fuel gas outlet, the cooling water inlet, and the cooling water outlet. Further, if the cutout part were omitted for the purpose of arranging the tie rods in the inside of the fuel cell stack, first of all, the terminal part of the collecting electrode plate would protrude largely from the outer shape of the entire stack. Thus, in the fuel cell stack known to the public, it is not disclosed how the tie rods may be arranged in the inside of the fuel cell stack with employing the separator in which the cutout part is provided.

An example of the object of the present disclosure is to provide a fuel cell stack and a separator in which depression and protrusion in the outer shape of the fuel cell stack are allowed to be reduced and tie rods are allowed to be arranged in the inside of the fuel cell stack.

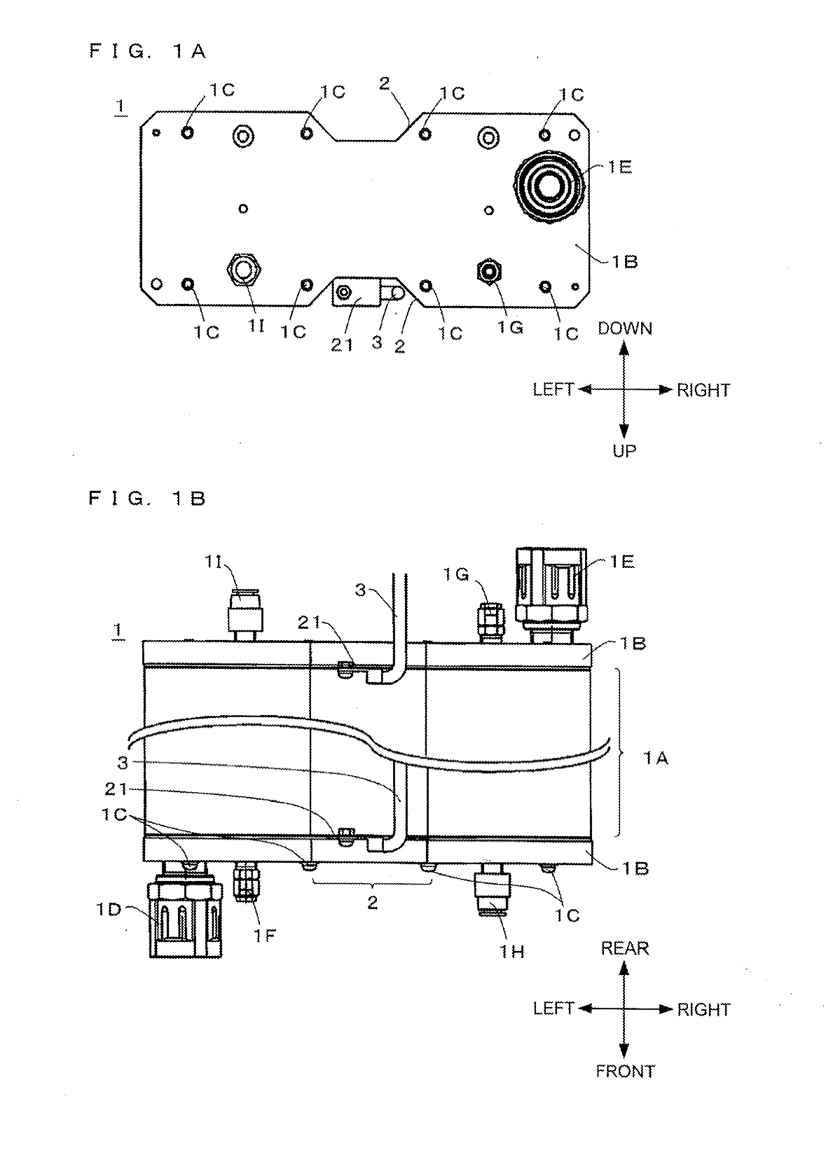

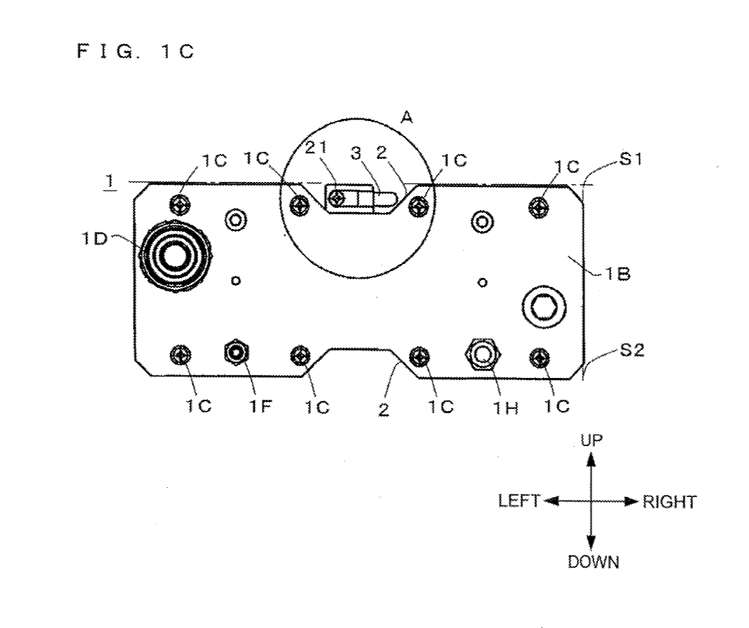

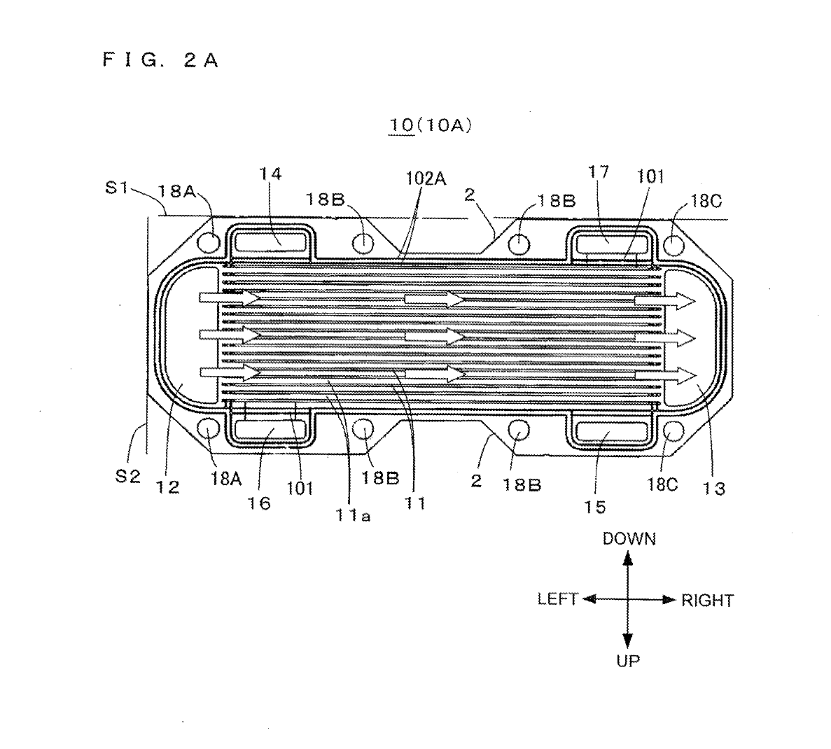

A fuel cell stack and a separator according to an embodiment of the present disclosure are described below with reference to FIGS. 1 to 6.

### <Overall Configuration>

A fuel cell stack 1 of the present embodiment includes a plurality of cells 1A, two end plates 1B, a collecting electrode plate 20, and eight bolts 1C. Each of the pair of end plates 1B has a rectangular planar shape. The plurality of cells 1A are stacked along the frontward and rearward directions. The frontward and rearward directions are the directions in which the plurality of cells 1A are stacked. Further, as illustrated in FIGS. 1A to 1C, the longer-side direction of the rectangle constituting each of the pair of end plates 1B is adopted as the right and left directions, and the shorter-side direction of the rectangle constituting each of the pair of end plates 1B is adopted as the up and down directions. The pair of end plates 1B pinch both ends of the frontward and rearward directions of the plurality of cells 1A. The eight bolts 1C fix the plurality of cells 1A and the pair of end plates 1B with each other. Each of the eight bolts 1C penetrates both of the pair of end plates LB and fixes the pair of end plates 1B and the plurality of cells 1A. In the eight bolts 1C, four bolts each are arranged at equal intervals along each of first sides S1 which are a pair of longer sides opposite to each other in the end plate 1B, that is, along the right and left directions. Here, the bolts 1C are an example of the tie rods. In place of the bolts 1C, un-threaded shafts may be employed as long as the pair of end plates 1B and the plurality of cells 1A are allowed to be fastened.

As illustrated in FIG. 1A, the end plate 1B on the rear side is provided with an oxidation gas discharge part 1E, a fuel gas discharge part 1G, and a cooling medium discharge part 1I. The oxidation gas discharge part 1E, the fuel gas discharge part 1G, and the cooling medium discharge part 1I are provided at mutually different positions in the end plate 1B on the rear side. For example, the oxidation gas discharge part 1E is provided at a right end of the end plate 1B on the rear side. The fuel gas discharge part 1G is provided in an upper right part of the end plate 1B on the rear side. The cooling medium discharge part 1I is provided in an upper left part of the end plate 1B on the rear side. Further, as illustrated in FIG. 1C, the end plate 1B on the front side is provided with an oxidation gas introduction part 1D, a fuel gas introduction part 1F, and a cooling medium introduction part 1H. The oxidation gas introduction part 1D, the fuel gas introduction part 1F, and the cooling medium introduction part 1H are provided at mutually different positions in the end plate 1B on the front side. For example, the oxidation gas introduction part 1D is provided at a left end of the end plate 1B on the front side. The fuel gas introduction part 1F is provided in a lower left part of the end plate 1B on the front side. The cooling medium introduction part 1H is provided in a lower right part of the end plate LB on the front side.

In the end plate 1B on the rear side, through holes penetrating in the frontward and rearward directions are formed respectively at the positions of the oxidation gas discharge part 1E, the fuel gas discharge part 1G, and the cooling medium discharge part 1I. Further, in the end plate 1B on the front side, through holes penetrating in the frontward and rearward directions are formed respectively at the positions of the oxidation gas introduction part 1D, the fuel gas introduction part 1F, and the cooling medium introduction part 1H. The oxidation gas introduction part 1D is connected to a pipe (not illustrated) into which oxidation gas from an oxidation gas supply source flows. The oxidation gas having flowed into the plurality of cells 1A through the through hole of the oxidation gas introduction part 1D passes through the inside of the plurality of cells 1A and then passes through the through hole of the oxidation gas discharge part 1E so as to be discharged through a pipe (not illustrated) connected to the oxidation gas discharge part 1E. In the present embodiment, the oxidation gas is a gas (e.g., air) containing oxygen (O₂). For example, the oxidation gas supply source is an air pump, an oxygen cylinder, or the like. The fuel gas introduction part 1F is connected to a pipe (not illustrated) into which fuel gas from a fuel gas supply source flows. The fuel gas having flowed into the plurality of cells 1A through the through hole of the fuel gas introduction part 1F passes through the inside of the plurality of cells 1A and then passes through the through hole of the fuel gas discharge part 1G so as to be discharged through a pipe (not illustrated) connected to the fuel gas discharge part 1G. In the present embodiment, the fuel gas is a gas containing hydrogen (H₂). For example, the fuel gas supply source is a high-pressure fuel gas cylinder, a fuel gas storage alloy, or the like. The cooling medium introduction part 1H is connected to a pipe (not illustrated) into which cooling medium from a cooling medium supply source flows. The cooling medium having flowed into the plurality of cells 1A through the through hole of the cooling medium introduction part 1H passes through the inside of the plurality of cells 1A and then passes through the through hole of the cooling medium discharge part 1I so as to be discharged through a pipe (not illustrated) connected to the cooling medium discharge part 1I. In the present embodiment, for example, the cooling medium is water.

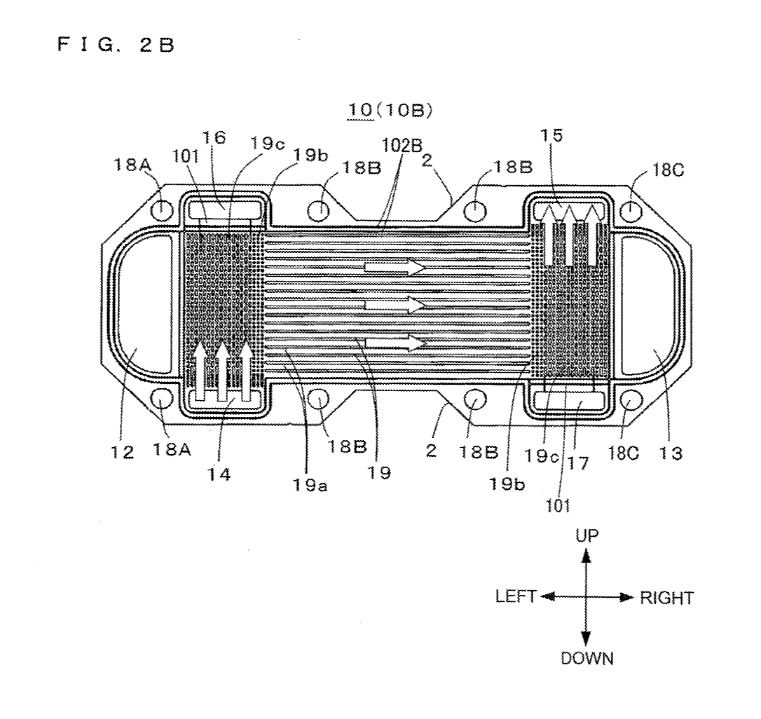

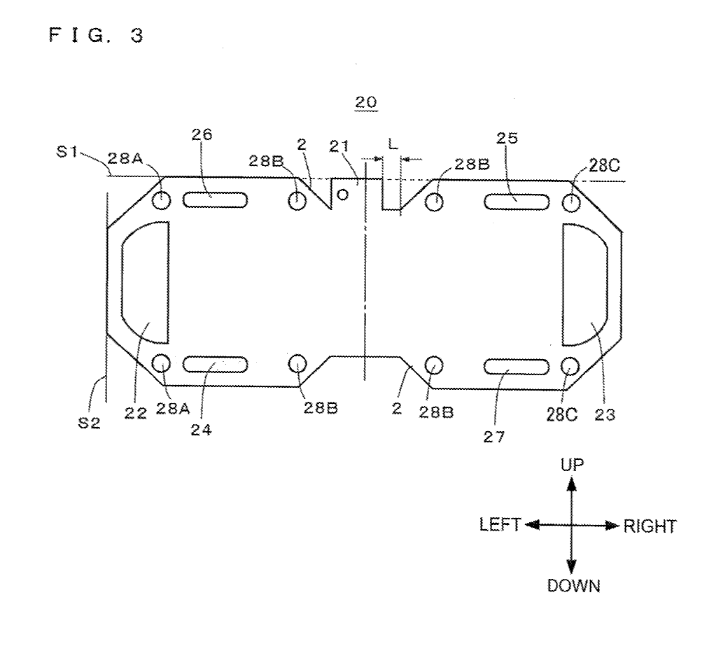

As illustrated in FIGS. 2, 4, and 5, each cell 1A includes a membrane electrode assembly 4, a pair of gaskets 30, and a pair of separators 10. One of the pair of gaskets 30 is in contact with the frontward face of the membrane electrode assembly 4 and the other of the pair of gaskets 30 is in contact with the rearward face of the membrane electrode assembly 4. The pair of separators 10 pinch the membrane electrode assembly 4 respectively in contact with the pair of gaskets 30. In each of the separators 10 located at both ends in the frontward and rearward directions of the plurality of cells 1A, the collecting electrode plate 20 illustrated in FIG. 3 is stacked adjacent thereto. The membrane electrode assembly 4, the separator 10, the collecting electrode plate 20, and the gasket 30 are described later in detail with reference to FIGS. 2A, 2B, 3, 4, and 5.

Then, as illustrated in FIGS. 1A and 1C, in the center in a pair of the longer sides opposite to each other of each separator 10 (see FIGS. 2A and 2B) constituting each of the plurality of cells 1A and of each end plate 1B, a cutout part 2 is provided respectively. As illustrated in FIG. 1B, when the fuel cell stack 1 is constructed, all cutout parts 2 of the individual separators 10 and the individual end plates 1B agree with each other so that a concave groove extending from the front face to the rear face of the fuel cell stack 1 is formed along the frontward and rearward directions.

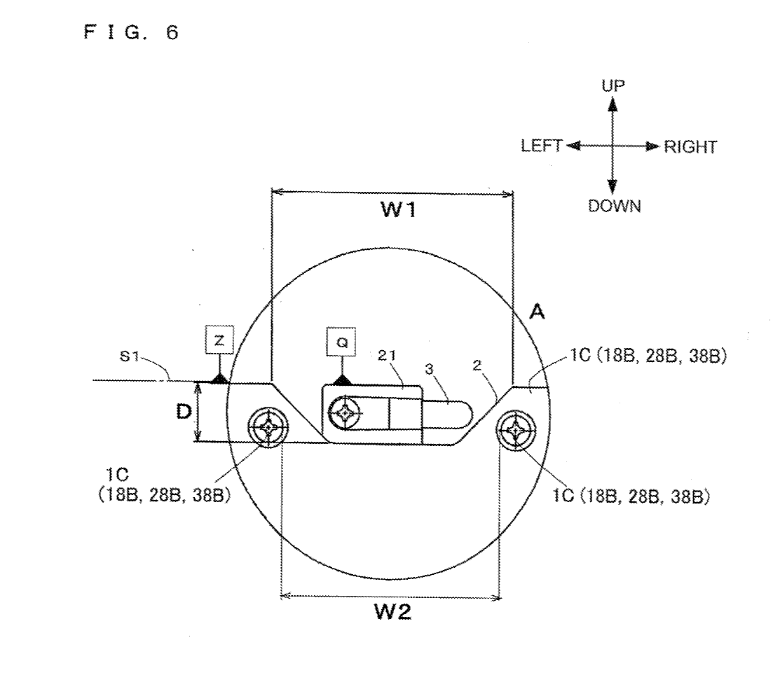

As illustrated in FIGS. 1B and 1C, a terminal part 21 of each collecting electrode plate 20 protrudes at each of both ends of the concave groove formed by the upper cutout part 2 of the fuel cell stack 1. Each terminal part 21 is connected to a power supply wiring 3 for extracting generated electricity. Front-side one of the power supply wirings 3 is led along the concave groove formed by the cutout part 2. The relation between the cutout part 2 and the terminal part 21 in part A in FIG. 1C is described later in detail with reference to FIG. 6.

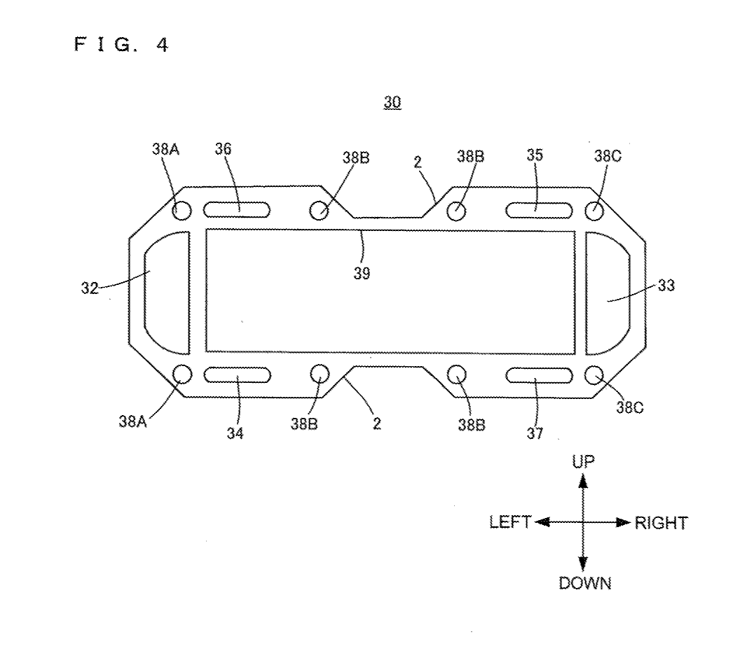

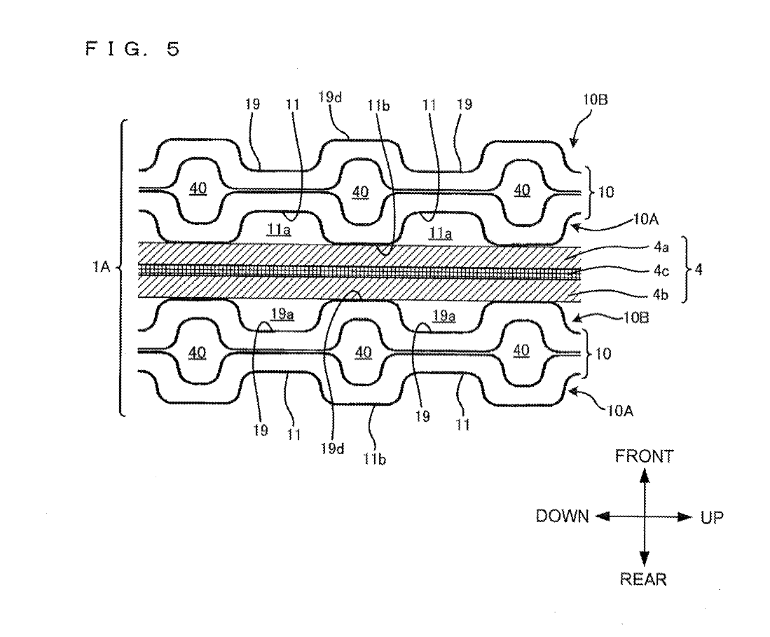

The cell 1A is constructed from the membrane electrode assembly 4, a pair of the gaskets 30, and a pair of the separators 10. One of the pair of gaskets 30 is in contact with the frontward face of the membrane electrode assembly 4 and the other of the pair of gaskets 30 is in contact with the rearward face of the membrane electrode assembly 4. The pair of separators 10 pinch the membrane electrode assembly 4 respectively in contact with the pair of gaskets 30. The separator 10 illustrated in FIGS. 2A and 2B, the gasket 30 illustrated in FIG. 4, the membrane electrode assembly 4 illustrated in FIG. 5 are described below.

### <Membrane Electrode Assembly>

The membrane electrode assembly 4 has a rectangular planar shape. As illustrated in FIG. 5, the membrane electrode assembly 4 includes a cathode electrode 4a, an anode electrode 4b, and a solid polyelectrolyte membrane 4c. The solid polyelectrolyte membrane 4c has electrical conductivity for proton in a moisture state. The solid polyelectrolyte membrane 4c is constructed from fluorine polymer such as Nafion (registered trademark) having a sulfonic acid group.

The cathode electrode 4a is in contact with the front-side face of the solid polyelectrolyte membrane 4c. The cathode electrode 4a includes a catalyst layer and a gas diffusion layer. The gas diffusion layer has electrical conductivity and oxidation gas (e.g., air) permeability. For example, the gas diffusion layer is constructed from carbon paper or the like. The catalyst layer contains a catalyst constructed mainly from carbon powder carrying a metal catalyst of platinum family. For example, the catalyst layer is formed by coating a paste in which a catalyst is dispersed in an organic solvent onto the carbon paper constituting the gas diffusion layer.

The anode electrode 4b is in contact with the rear-side face of the solid polyelectrolyte membrane 4c. The anode electrode 4b includes a catalyst layer and a gas diffusion layer. The gas diffusion layer has electrical conductivity and fuel gas (e.g., hydrogen) permeability. For example, the gas diffusion layer is constructed from carbon paper or the like. The catalyst layer contains a catalyst constructed mainly from carbon powder carrying a metal catalyst of platinum family. For example, the catalyst layer is formed by coating a paste in which a catalyst is dispersed in an organic solvent onto the carbon paper constituting the gas diffusion layer.

### <Separator>

The separator 10 constituting the above-mentioned fuel cell stack 1 of the present embodiment is described below with reference to FIGS. 2A, 2B, and 5.

First, FIGS. 2A and 2B respectively illustrate both faces of one separator 10, that is, a first surface 10A on the cathode side where the oxidation gas flows and a second surface 10B on the anode side where the fuel gas flows. In the present embodiment, the separator 10 is constructed from two metal plates having a thickness of 1 mm or the like. The metal plate may be formed from an arbitrary metallic material including stainless steels and aluminum alloys. Specifically, press working is performed on each of the two metal plates so that the concave-convex shape illustrated in FIGS. 2A and 2B is formed. The two metal plates having undergone press working are bonded together so that one separator 10 is formed.

Then, one of the pair of separators 10 constituting the cell 1A is arranged such that the first surface 10A illustrated in FIG. 2A faces the cathode electrode 4a of the membrane electrode assembly 4. That is, the first surface 10A and the cathode electrode 4a of the membrane electrode assembly 4 face each other. As a result, a passage 11a for the oxidation gas is formed. Further, the other of the pair of separators 10 constituting the cell 1A is arranged such that the second surface 10B illustrated in FIG. 2B faces the anode electrode 4b of the membrane electrode assembly 4. That is, the second surface 10B and the anode electrode 4b of the membrane electrode assembly 4 face each other. As a result, a passage 19a for the fuel gas is formed. Further, in the inside of one separator 10, a passage 40 in which concave shapes each obtained by reversing the convex shape formed in the surface of each of the two metal plates are oppose to each other is formed. The cooling medium described above is supplied to the internal passage of the separator 10.

### <<Passage, Cutout Part, and Aperture on Cathode Side>>

The separator 10 of the present embodiment has a horizontally elongated shape with dimensions corresponding to the end plates 1B described above. The separator 10 has: first sides S1 which are a pair of longer sides opposite to each other; and second sides S2 which are a pair of shorter sides opposite to each other.

As illustrated in FIGS. 2A and 2B, in the present embodiment, first holes 14 and 16, second holes 15 and 17, third holes 18B, fourth holes 18A, fifth holes 18C, a sixth hole 12, and a seventh hole 13 are formed at mutually different positions in the separator 10. The sixth hole 12 penetrates the separator 10 in the frontward and rearward directions at one end of the separator 10 in the right and left directions. Specifically, the sixth hole 12 is formed on one shorter-side side of the rectangle (i.e., on the left end side of the separator 10) and extends in the up and down directions. The sixth hole 12 is formed at a position corresponding to the oxidation gas introduction part 1D.

The seventh hole 13 penetrates the separator 10 in the frontward and rearward directions at the other end of the separator 10 in the right and left directions. Specifically, the seventh hole 13 is formed on the other shorter-side side of the rectangle (i.e., on the right end side of the separator 10) and extends in the up and down directions. The seventh hole 13 is formed at a position corresponding to the oxidation gas discharge part 1E.

The first hole 14 is formed on one end side of the separator 10 in the right and left directions. The first hole 14 is located between a plurality of first grooves 11 described later and the outer edge along the right and left directions of the separator 10 in the up and down directions and penetrates the separator 10 in the frontward and rearward directions. Specifically, the first hole 14 is formed on one longer-side side of the rectangle (i.e., on the lower end side of the separator 10) and on one shorter-side side of the rectangle (i.e., on the left end side of the separator 10) and extends in the right and left directions. The first hole 14 is formed at a position corresponding to the fuel gas introduction part 1F.

The first hole 16 is formed on one end side of the separator 10 in the right and left directions. The first hole 16 is provided on a side opposite to the first hole 14 relative to a plurality of first grooves 11 described later in the up and down directions. Specifically, the first hole 16 is formed on the other longer-side side of the rectangle (i.e., on the upper end side of the separator 10) and on one shorter-side side of the rectangle (i.e., on the left end side of the separator 10) and extends in the right and left directions. The first hole 16 is formed at a position corresponding to the cooling medium discharge part 1I.

The second hole 17 is formed on the other end side of the separator 10 in the right and left directions. The second hole 17 penetrates the separator 10 between a plurality of first grooves 11 described later and the outer edge along the right and left directions of the separator 10. Specifically, the second hole 17 is formed on one longer-side side of the rectangle (i.e., on the lower end side of the separator 10) and on the other shorter-side side of the rectangle (i.e., on the right end side of the separator 10) and extends in the right and left directions. The second hole 17 is formed at a position corresponding to the cooling medium introduction part 1H.

The second hole 15 is formed on the other end side of the separator 10 in the right and left directions. The second hole 15 is provided on a side opposite to the second hole 17 relative to a plurality of first grooves 11 described later. Specifically, the second hole 15 is formed on the other longer-side side of the rectangle (i.e., on the upper end side of the separator 10) and on the other shorter-side side of the rectangle (i.e., on the right end side of the separator 10) and extends in the right and left directions. The second hole 15 is formed at a position corresponding to the fuel gas discharge part 1G.

As illustrated in FIGS. 2A and 5, in a center part of the first surface 10A, a plurality of first grooves 11 along the right and left directions are formed at equal intervals in the up and down directions. The plurality of first grooves 11 extend along the right and left directions from the sixth hole 12 to the seventh hole 13. In other words, the sixth hole 12 is formed between the plurality of first grooves 11 and the left end of the separator 10. The seventh hole 13 is formed between the plurality of first grooves 11 and the right end of the separator 10. For example, the plurality of first grooves 11 are formed into a concave-convex shape by pressing or the like by bending in the frontward and rearward directions the plate on the rear side of the separator 10. Specifically, each of the plurality of first grooves 11 is constructed from a bottom surface depressed toward the front side and a pair of side surfaces located in the up and down directions of the bottom surface in the first surface 10A. A first protrusion 11b is located between two adjacent first grooves 11 in the up and down directions. The first protrusion 11b extends along the right and left directions from the sixth hole 12 to the seventh hole 13.

The region of approximately rectangular shape containing the plurality of first grooves 11 corresponds to the outer shape of the cathode electrode 4a of the membrane electrode assembly 4. As illustrated in FIG. 5, the first protrusion 11b is in contact with the cathode electrode 4a. Further, the plurality of first grooves 11 and the cathode electrode 4a are separated from each other in the frontward and rearward directions. That is, the space formed between the plurality of first grooves 11 and the cathode electrode 4a is the first passage 11a through which the oxidation gas flows.

In the first surface 10A, third protrusions 102A are formed continuously. The third protrusions 102A are so-called gasket line for pressing the gasket 30 described later. Similarly to the plurality of first grooves 11, the third protrusions 102A are formed by pressing or the like by bending in the frontward and rearward directions the plate on the rear side of the separator 10. Here, the third protrusions 102A may be formed by using a construction material different from the separator 10. The third protrusions 102A enclose the plurality of first grooves 11, the first holes 14 and 16, the second holes 15 and 17, the sixth hole 12, and the seventh hole 13 without a break. In the present embodiment, as illustrated in FIG. 2A, the third protrusions 102A are formed in the first surface 10A and enclose the plurality of first grooves 11, the sixth hole 12, and the seventh hole 13. Further, the third protrusions 102A are formed in the first surface 10A and enclose the first holes 14 and 16 separately. Further, the third protrusions 102A are formed in the first surface 10A and enclose the second holes 15 and 17 separately.

When the separator 10 and the later-described gasket 30 are stacked, the third protrusions 102A contact with the surface of the gasket 30. By virtue of this, the plurality of first grooves 11, the first holes 14 and 16, the second holes 15 and 17, the sixth hole 12, and the seventh hole 13 are sealed by the gasket 30. The gasket 30 avoids leakage of the oxidation gas, the fuel gas, and the cooling medium to the outside of the fuel cell stack 1.

Then, mutually adjacent two third holes 18B, the fourth hole 18A, and the fifth hole 18C are formed at equal intervals along the first side S1 on the lower side of the separator 10. Similarly, mutually adjacent two third holes 18B, the fourth hole 18A, and the fifth hole 18C are formed at equal intervals along the first side S1 on the upper side of the separator 10. That is, in the separator 10, four third holes 18B, two fourth holes 18A, and two fifth holes 18C are formed in total. Then, the eight bolts 1C described above are inserted respectively.

The two third holes 18B are formed in the lower end part of the separator 10. Specifically, the two third holes 18B are formed between the first hole 14 and the second hole 17 in the right and left directions and between the third protrusion 102A plus the plurality of grooves 11 and the lower outer edge part of the separator 10 in the up and down directions. The two third holes 18B are adjacent to each other. Similarly, also in the upper end part of the separator 10, mutually adjacent two third holes 18B are formed. Specifically, the two third holes 18B are formed between the first hole 16 and the second hole 15 in the right and left directions and between the third protrusion 102A plus the plurality of grooves 11 and the upper outer edge part of the separator 10 in the up and down directions.

The fourth hole 18A is formed in the lower left end part of the separator 10. Specifically, the fourth hole 18A is formed between the third protrusions 102A enclosing the first hole 14 and the outer edge part of the separator 10 in the right and left directions. The fourth hole 18A is located on a side opposite to left side one of the third holes 18B relative to the first hole 14 in the right and left directions. The fourth hole 18A is located between the sixth hole 12 plus the third protrusions 102A and the lower outer edge part of the separator 10 in the up and down directions. Similarly, the fourth hole 18A is formed also in an upper left end part of the separator 10. Specifically, the fourth hole 18A is formed between the third protrusions 102A enclosing the first hole 16 and the outer edge part of the separator 10 in the right and left directions. The fourth hole 18A is located on a side opposite to left side one of the third holes 18B relative to the first hole 16 in the right and left directions. The fourth hole 18A is located between the sixth hole 12 plus the third protrusion 102A and the upper outer edge part of the separator 10 in the up and down directions.

The fifth hole 18C is formed in the lower right end part of the separator 10. Specifically, the fifth hole 18C is formed between the third protrusions 102A enclosing the second hole 17 and the outer edge part of the separator 10 in the right and left directions. The fifth hole 18C is located on a side opposite to right side one of the third holes 18B relative to the second hole 17 in the right and left directions. The fifth hole 18C is located between the seventh hole 13 plus the third protrusion 102A and the lower outer edge part of the separator 10 in the up and down directions. The fifth hole 18C is formed also in an upper right end part of the separator 10. Specifically, the fifth hole 18C is formed between the third protrusion 102A enclosing the second hole 15 and the outer edge part of the separator 10 in the right and left directions. The fifth hole 18C is located on a side opposite to right side one of the third hole 18B relative to the second hole 15 in the right and left directions. The fifth hole 18C is located between the seventh hole 13 plus the third protrusion 102A and the upper outer edge part of the separator 10 in the up and down directions.

In the center of each of the first sides S1 in the right and left directions of the separator 10, the cutout parts 2 are formed. These cutout parts 2 are located respectively between the two mutually adjacent third holes 18B located on both side of the center of the first side S1 in the right and left directions. Specifically, the cutout part 2 located on the lower side is formed in the lower outer edge part of the separator 10 so as to approach the third protrusions 102A and the plurality of grooves 11 in the up and down directions. Similarly, the cutout part 2 located on the upper side is formed in the upper outer edge part of the separator 10 so as to approach the third protrusions 102A and the plurality of grooves 11 in the up and down directions.

### <<Passage on Anode Side>>

In FIG. 2B, in the center of the second surface 10B of the separator 10, a plurality of second grooves 19 along the right and left directions are formed at equal intervals in the up and down directions. The plurality of second grooves 19 extend along the right and left directions between the sixth hole 12 and the seventh hole 13. For example, the plurality of second grooves 19 is formed into a concave-convex shape by pressing or the like by bending in the frontward and rearward directions the plate on the front side of the separator 10. Specifically, each of the plurality of second grooves 19 is constructed from a bottom surface depressed toward the rear side and a pair of side surfaces located in the up and down directions of the bottom surface in the second surface 10B. A second protrusion 19d is located between two adjacent second grooves 19 in the up and down directions. The second protrusion 19d extends along the right and left directions between the sixth hole 12 and the seventh hole 13. The plurality of second grooves 19 are shorter than the plurality of first grooves 11 in the right and left directions. A diffusion region 19b and a transition region 19c are formed between the left end of the plurality of second grooves 19 and the sixth hole 12. Similarly, a diffusion region 19b and a transition region 19c are formed between the right end of the plurality of second grooves 19 and the seventh hole 13.

In the transition region 19c, a large number of protrusions of elliptical shape are formed. These protrusions of elliptical shape individually extend in the direction of the second side S2 which is the shorter side of the separator 10, that is, in the up and down directions. In the transition region 19c on the left side, the direction of flow of the fuel gas supplied from the first hole 14 of the separator 10 is transited from the up and down directions into the right and left directions. In the transition region 19c on the right side, the direction of flow of the fuel gas having passed the diffusion region 19b on the right side is transited from the right and left directions into the up and down directions.

On the other hand, in the diffusion region 19b, a large number of protrusions of circular shape are formed. In the diffusion region 19b, the fuel gas having passed the transition region 19c on the left side of the separator 10 and the fuel gas having passed the right end of the plurality of second grooves 19 are diffused homogeneously by the protrusions of circular shape in the entire region.

The region of approximately rectangular shape containing the plurality of second grooves 19, the pair of diffusion regions 19b, and the pair of transition regions 19c corresponds to the outer shape of the anode electrode 4b of the membrane electrode assembly 4. As illustrated in FIG. 5, the second protrusion 19d is in contact with the anode electrode 4b. Further, the plurality of second grooves 19 and the anode electrode 4b are separated from each other in the frontward and rearward directions. The apex part of the protrusion of circular shape in the diffusion region 19b is in contact with the anode electrode 4b. The peripheral part of the protrusion of circular shape in the diffusion region 19b and the anode electrode 4b are separated from each other in the frontward and rearward directions. The apex part of the protrusion of elliptical shape in the transition region 19c is in contact with the anode electrode 4b. The peripheral part of the protrusion of elliptical shape in the transition region 19c and the anode electrode 4b are separated from each other in the frontward and rearward directions. That is, the space between the plurality of second grooves 19 and the anode electrode 4b, the space between the peripheral part of the protrusion of circular shape in the diffusion region 19b and the anode electrode 4b, and the space between the peripheral part of the protrusion of elliptical shape in the transition region 19c and the anode electrode 4b are the second passage 19a through which the fuel gas flows.

In the second surface 10B, third protrusions 102B are formed continuously. The third protrusions 102B are so-called gasket line for pressing the gasket 30 described later. The third protrusions 102B are formed by pressing or the like by bending in the frontward and rearward directions the plate on the front side of the separator 10. Here, the third protrusions 102B may be formed by using a construction material different from the separator 10. The third protrusions 102B enclose without a break: a region of approximately rectangular shape containing the plurality of second grooves 19, the pair of diffusion regions 19b, and the pair of transition regions 19c; the first holes 14 and 16; the second holes 15 and 17; the sixth hole 12; and the seventh hole 13. In the present embodiment, as illustrated in FIG. 2B, the third protrusions 102B are formed in the second surface 10B and enclose: a region of approximately rectangular shape containing the plurality of second grooves 19, the pair of diffusion regions 19b, and the pair of transition regions 19c; the first hole 14; and the second hole 15. Further, the third protrusions 102B are formed in the second surface 10B and encloses the first hole 16. Further, the third protrusions 102B are formed in the second surface 10B and enclose the second hole 17. Further, the third protrusions 102B are formed in the second surface 10B and enclose the sixth hole 12. Further, the third protrusions 102B are formed in the second surface 10B and enclose the seventh hole 13.

When the separator 10 and the later-described gasket 30 are stacked, the third protrusions 102B contact with the surface of the gasket 30. By virtue of this, a region of approximately rectangular shape containing the plurality of second grooves 19, the pair of diffusion regions 19b, and the pair of transition regions 19c; the first holes 14 and 16; the second holes 15 and 17; the sixth hole 12; and the seventh hole 13 are sealed by the gasket 30. The gasket 30 avoids leakage of the oxidation gas, the fuel gas, and the cooling medium to the outside of the fuel cell stack 1.

### <<Internal Passage>>

Further, the internal passage of the separator 10 for circulation of the cooling medium is described below. As described above, the internal passage of the separator 10 is formed when concave shapes each obtained by reversing the convex shape formed in the surface of each of the two metal plates illustrated in FIGS. 2A and 2B are arranged opposite to each other.

Here, in the present embodiment, the length in the up and down directions of the protrusion of elliptical shape formed in the transition region 19c illustrated in FIG. 2B is set up larger than the length between mutually adjacent two first grooves 11 formed in the first surface 10A. By virtue of this configuration, the recess obtained by reversing the protrusion of elliptical shape of the transition region 19c overlaps with the recess obtained by reversing mutually adjacent two first grooves 11 so that the internal passage in fluid communication in the up, down, right, and left directions in FIG. 2B is formed. As illustrated in FIGS. 2A and 2B, the internal passage is connected in the up and down directions to the first hole 16 through the cooling medium passage part 101 located on the upper left side. Further, the internal passage is connected to the second hole 17 in the up and down directions through the cooling medium passage part 101 located on the lower right side. The cooling medium passage part 101 is formed by separation in the frontward and rearward directions of the two metal plates constituting the separator 10. Further, as illustrated in FIG. 5, a cooling medium passage 40 is defined between the recess obtained by reversing the first protrusion 11b in the first surface 10A and the recess obtained by reversing the second protrusion 19d in the second surface 10B. As a result, the cooling medium supplied from the first hole 16 flows through the cooling medium passage part 101, through the recess obtained by reversing the protrusion of elliptical shape in the transition region 19c on the left end side of the separator 10, into the recess obtained by reversing the plurality of first grooves 11. The cooling medium flows through the cooling medium passage 40 from the left side to the right side. The cooling medium flows through the recess obtained by reversing the protrusion of elliptical shape in the transition region 19c on right end side of the separator 10 and then is discharged from the second hole 17 through the cooling medium passage part 101.

### <Collecting Electrode Plate>

Next, the collecting electrode plate 20 constituting the above-mentioned fuel cell stack 1 of the present embodiment is described below with reference to FIG. 3.

In FIG. 3, the collecting electrode plate 20 is fabricated from a metal plate having the same outer shape as the separator 10 described above. Through holes penetrating the collecting electrode plate 20 in the frontward and rearward directions are formed respectively at positions corresponding to the first holes 14 and 16, the second holes 15 and 17, the third holes 18B, the fourth holes 18A, the fifth holes 18C, the sixth hole 12, and the seventh hole 13 illustrated in FIGS. 2A and 2B. Specifically, in the example of FIG. 3, a through hole 22 is formed on the left end side of the collecting electrode plate 20 and extends in the up and down directions. Further, a through hole 23 is formed on the right end side of the collecting electrode plate 20 and extends in the up and down directions. Here, in the present embodiment, the outer shape and the position of the through hole 22 correspond respectively to the outer shape and the position of the sixth hole 12 of the separator 10. Further, the outer shape and the position of the through hole 23 correspond respectively to the outer shape and the position of the seventh hole 13 of the separator 10.

Further, in the example of FIG. 3, a through hole 27 is formed on the lower end side of the collecting electrode plate 20 and on the right end side of the collecting electrode plate 20 and extends in the right and left directions. Further, a through hole 26 is formed on the upper end side of the collecting electrode plate 20 and on the left end side of the collecting electrode plate 20 and extends in the right and left directions. Here, in the present embodiment, the outer shape and the position of the through hole 27 correspond respectively to the outer shape and the position of the second hole 17 of the separator 10. Further, the outer shape and the position of the through hole 26 correspond respectively to the outer shape and the position of the first hole 16 of the separator 10.

Further, in the example of FIG. 3, a through hole 24 is formed on the lower end side of the collecting electrode plate 20 and on the left end side of the collecting electrode plate 20 and extends in the right and left directions. Further, a through hole 25 is formed on the upper end side of the collecting electrode plate 20 and on the right end side of the collecting electrode plate 20 and extends in the right and left directions. Here, in the present embodiment, the outer shape and the position of the through hole 24 correspond respectively to the outer shape and the position of the first hole 14 of the separator 10. Further, the outer shape and the position of the through hole 25 correspond respectively to the outer shape and the position of the second hole 15 of the separator 10.

In the vicinity of each of the longer sides S1 of the rectangle of the collecting electrode plate 20, through holes 28A, 28B, and 28C are formed. In the example of FIG. 3, the through holes 28A, 28B, and 28C are formed at equal intervals in the right and left directions in the collecting electrode plate 20. The outer shape and the position of through holes 28A correspond to the outer shape and the position of the fourth holes 18A of the separator 10. The outer shape and the position of through holes 28B correspond to the outer shape and the position of the third holes 18B of the separator 10. The outer shape and the position of through holes 28C correspond to the outer shape and the position of the fifth holes 18C of the separator 10.

In the center in the right and left directions of each of the first sides S1 which are the longer sides of the collecting electrode plate 20, the cutout parts 2 are formed. The outer shape and the position of each cutout parts 2 correspond to the outer shape and the position of each cutout parts 2 formed in the separator 10.

Here, in contrast to the separator 10 described above, the terminal part 21 is formed in the upper cutout part 2 of the collecting electrode plate 20 illustrated in FIG. 3. The terminal part 21 protrudes in a direction (e.g., upward) intersecting the first side S1 which is the longer side of the collecting electrode plate 20. In the present embodiment, the position of the upper end of the terminal part 21 is the same as the position (see a dotted line in FIG. 3) of the upper end of the first side S1. By virtue of the cutout part 2, the terminal part 21 does not protrude beyond the upper end of the first side S1.

Further, in the present embodiment, the center position in the right and left directions of the terminal part 21 is offset leftward relative to the center (see a dash-dotted line in FIG. 3) in the right and left directions of the cutout part 2. By virtue of this configuration, a handling space L for the power supply wiring 3 (see FIG. 1) is formed in the cutout part 2. Thus, the power supply wiring 3 connected to the terminal part 21 is satisfactorily accommodated in the cutout part 2.

Here, in the present embodiment, a configuration has been employed that a groove through which the oxidation gas or the fuel gas flows is not formed in the collecting electrode plate 20. However, the collecting electrode plates 20 are stacked on both ends of the stack 1A which is a stacked body of the unit battery cells. Thus, for example, a configuration may be employed that a groove through which the oxidation gas or the fuel gas flows is formed in any one face.

### <Relation Between Cutout Part and Terminal Part>

Next, the relation between the cutout part 2 described above and the terminal part 21 is described below with reference to FIG. 6. In the following description, the cutout part 2 is premised to indicate the cutout part 2 of each of the end plate 1B illustrated in FIGS. 1A to 1C, the separator 10 illustrated in FIGS. 2A and 2B, the collecting electrode plate 20 illustrated in FIG. 3, and the gasket 30 illustrated in FIG. 4.

As illustrated in FIG. 6, in the present embodiment, the depth D (the length in the up and down directions) of the cutout part 2 is set up such that the most upward protruding part Q of the terminal part 21 is located at the same position or below in the up and down directions relative to the most upward protruding part Z of the end plate 1B, the separator 10, and the collecting electrode plate 20. In the present embodiment, the part Z corresponds to the first side S1 which is the longer side extending in the right and left directions. In order that the terminal part 21 may not protrude upward beyond the first side S1, in addition to the position in the up and down directions of the part Q of the terminal part 21, the depth D of the cutout part 2 is of importance.

Here, the depth D of the cutout part 2 may be set up so as to satisfy a further condition for permitting easy terminal connection of the power supply wiring 3. For example, when a crimp-type terminal is used for connection of the power supply wiring 3, the depth D of the cutout part 2 is set to be 17 mm or deeper and, at the same time, an opening width W1 of the cutout part 2 is set to be 60 to 80 mm and, preferably, to be 75 mm. Here, the opening width W1 is the maximum distance in the right and left directions of the cutout part 2. When the depth D of the cutout part 2 is set to be 17 mm or deeper and the opening width W1 of the cutout part 2 is set to be within the range of 60 to 80 mm, the state of connection of the crimp-type terminal to the terminal part 21 is stabilized. Further, connection work using bolts or nuts becomes easy and handling of the power supply wiring 3 after the connection also becomes easy.

In the present embodiment, the cutout part 2 is formed by cutting out the separator 10 into a trapezoidal shape whose upper base and lower base have mutually different lengths. Specifically, the distance in the right and left directions of the cutout part 2 becomes larger as departing from the plurality of first grooves 11. Then, the opening width W1 of the cutout part 2 is larger than a width W2 of the interval formed respectively by the two third holes 18B, the two through holes 28B, and the two through holes 38B adjacent to each other located on both sides of the center of the first side S1. That is, the opening width W1 of the cutout part 2 is allowed to be made large in a state that interference with the formation positions of the third holes 18B, the through holes 28B, and the through holes 38B is avoided.

### <Gasket>

As illustrated in FIG. 4, the gasket 30 is a sheet having an approximately rectangular planar shape. For example, the gasket 30 is constructed from an elastic material such as rubber and elastomer processed into a remarkably thin shape. In the gasket 30, through holes 32, 33, 34, 35, 36, 37, 38A, 38B, 38C, and 39 are formed so as to penetrate the plane in the frontward and rearward directions.

In the center part of the plane of the gasket 30, the through hole 39 having the largest rectangular shape is formed. The outer shape and the position of the through hole 39 in the gasket 30 correspond to the outer shape and the position of the region of approximately rectangular shape where the plurality of first grooves 11 of the separator 10 are formed. Further, the outer shape and the position of the through hole 39 in the gasket 30 correspond also to the outer shape and the position of the region of approximately rectangular shape where the plurality of second grooves 19, the diffusion region 19b, and the transition region 19c of the separator 10 are formed. Further, the outer shape and the position of the through hole 39 in the gasket 30 correspond also to the outer shape and the position of the cathode electrode 4a and the anode electrode 4b of the membrane electrode assembly 4.

In the present embodiment, the through holes 32, 33, 34, 35, 36, 37, 38A, 38B, 38C, and 39 are formed at mutually different positions in the plane of the gasket 30. Specifically, in the example of FIG. 4, the through hole 32 is formed on the left end side of the gasket 30 and extends in the up and down directions. Further, the through hole 33 is formed on the right end side of the gasket 30 and extends in the up and down directions. Here, in the present embodiment, the outer shape and the position of the through hole 32 correspond respectively to the outer shape and the position of the sixth hole 12 of the separator 10. Further, the outer shape and the position of the through hole 33 correspond respectively to the outer shape and the position of the seventh hole 13 of the separator 10.

Further, in the example of FIG. 4, the through hole 37 is formed on the lower end side of the gasket 30 and on the right end side of the gasket 30 and extends in the right and left directions. Further, the through hole 36 is formed on the upper end side of the gasket 30 and on the left end side of the gasket 30 and extends in the right and left directions. Here, in the present embodiment, the outer shape and the position of the through hole 37 correspond respectively to the outer shape and the position of the second hole 17 of the separator 10. Further, the outer shape and the position of the through hole 36 correspond respectively to the outer shape and the position of the first hole 16 of the separator 10.

Further, in the example of FIG. 4, the through hole 34 is formed on the lower end side of the gasket 30 and on the left end side of the gasket 30 and extends in the right and left directions. Further, the through hole 35 is formed on the upper end side of the gasket 30 and on the right end side of the gasket 30 and extends in the right and left directions. Here, in the present embodiment, the outer shape and the position of the through hole 34 correspond respectively to the outer shape and the position of the first hole 14 of the separator 10. Further, the outer shape and the position of the through hole 35 correspond respectively to the outer shape and the position of the second hole 15 of the separator 10.

In the vicinity of each of the longer sides of the rectangle of the gasket 30, the through holes 38A, 38B, and 38C are formed. In the example of FIG. 4, the through holes 38A, 38B, and 38C are formed at equal intervals in the right and left directions in the gasket 30. The outer shape and the position of through hole 38A correspond to the outer shape and the position of the fourth hole 18A of the separator 10. The outer shape and the position of through hole 38B correspond to the outer shape and the position of the third hole 18B of the separator 10. The outer shape and the position of through hole 38C correspond to the outer shape and the position of the fifth hole 18C of the separator 10.

In the center of each of the longer sides in the right and left directions of the gasket 30, the cutout part 2 is formed. The outer shape and the position of each cutout parte 2 correspond to the outer shape and the position of each cutout part 2 formed in the separator 10.

### <Power Generation Operation>

The fuel gas supplied from the fuel gas introduction part 1F to the inside of the fuel cell stack 1 flows into a space defined by the first hole 14 of the separator 10, the through hole 24 of the collecting electrode plate 20, and the through hole 34 of the gasket 30 and extending in the frontward and rearward directions. The fuel gas flows through the first hole 14 into the second passage 19a described above. The fuel gas is diffused in the surface directions of the membrane electrode assembly 4 (i.e., in the up, down, right, and left directions) by the diffusion layer of the anode electrode 4b so as to go into contact with the catalyst layer of the anode electrode 4b. The hydrogen gas in the fuel gas in contact with the catalyst layer is dissociated into hydrogen ions and electrons by the catalyst contained in the catalyst layer. The hydrogen ions are conducted through the solid polyelectrolyte membrane 4c and then reach the catalyst layer of the cathode electrode 4a. On the other hand, the electrons are extracted to the outside through the terminal part 21 on the front side. The fuel gas in contact with the anode electrode 4b is discharged into a space defined by the second hole 15 of the separator 10, the through hole 25 of the collecting electrode plate 20, and the through hole 35 of the gasket 30 and extending in the frontward and rearward directions. After that, the fuel gas is discharged through the fuel gas discharge part 1G to the outside of the fuel cell stack 1.

On the other hand, the oxidation gas supplied to the oxidation gas introduction part 1D flows into a space defined by the sixth hole 12 of the separator 10, the through hole 22 of the collecting electrode plate 20, and the through hole 32 of the gasket 30 and extending in the frontward and rearward directions. The oxidation gas flows into the first passage 11a. The oxidation gas is diffused in the surface directions of the membrane electrode assembly 4 (i.e., in the up, down, right, and left directions) by the diffusion layer of the cathode electrode 4a so as to go into contact with the catalyst layer of the cathode electrode 4a. The oxygen contained in the oxidation gas generates water in association with a reaction with the hydrogen ions conducted through the solid polyelectrolyte membrane 4c and with the electrons extracted from the terminal part 21 on the front side and then conducted from the terminal part 21 on the rear side through an external load, which is caused by the catalyst contained in the catalyst layer. Electric power is generated in association with this electron transfer. The oxidation gas in contact with the cathode electrode 4a, together with the generated water, flows into a space defined by the seventh hole 13 of the separator 10, the through hole 23 of the collecting electrode plate 20, and the through hole 33 of the gasket 30 and extending in the frontward and rearward directions. After that, the oxidation gas is discharged through the oxidation gas discharge part 1E to the outside of the fuel cell stack 1.

### <Operation Effects>

In the fuel cell stack 1 described above, the two third holes 18B, the fourth hole 18A, and the fifth hole 18C are formed respectively at given intervals along both longer sides extending in the right and left directions of the separator 10. Then, on both longer sides extending in the right and left directions of the collecting electrode plate 20, the two through holes 28B, the through hole 28A, and the through hole 28C are formed respectively in correspondence to the two third holes 18B, the fourth hole 18A, and the fifth hole 18C. Similarly on both longer sides extending in the right and left directions of the gasket 30, the two through holes 38B, the through hole 38A, and the through hole 38C are formed respectively in correspondence to the two third holes 18B, the fourth hole 18A, and the fifth hole 18C. Between the two third holes 18B, the two through holes 28B, and the two through holes 38B adjacent to each other in the right and left directions, the cutout part 2 is formed in correspondence to the terminal part 21. The eight bolts 1C are accommodated in the inside of the fuel cell stack 1. Thus, depression and protrusion in the outer shape of the fuel cell stack 1 are allowed to be reduced. Further, by virtue of the cutout part 2, handling of the power supply wiring 3 connected to the terminal part 21 becomes easy. Then, the two third holes 18B formed on the lower side of the separator 10 are formed between the first hole 14 and the second hole 17 in the right and left directions and between the third protrusion 102A plus the plurality of grooves 11 and the lower outer edge part of the separator 10 in the up and down directions. Similarly, the two third holes 18B formed on the upper side of the separator 10 are formed between the first hole 16 and the second hole 15 in the right and left directions and between the third protrusion 102A plus the plurality of grooves 11 and the upper outer edge part of the separator 10 in the up and down directions. Thus, the bolts 1C are allowed to be arranged in the inside of the fuel cell stack 1 without affecting the positions of the plurality of grooves 11, the first holes 14 and 16, and the second holes 15 and 17 serving as a configuration necessary for power generation.

Further, the fourth hole 18A is located on a side opposite to the third hole 18B on the left side relative to the first hole 14 or 16 in the right and left directions. The fourth hole 18A is located, with respect to the up and down directions, between the sixth hole 12 plus the third protrusion 102A and the outer edge part of the separator 10 extending in the right and left directions. The fifth hole 18C is located on a side opposite to the third hole 18B on the right side relative to the second hole 15 or 17 in the right and left directions. The fifth hole 18C is located, with respect to the up and down directions, between the seventh hole 13 plus the third protrusion 102A and the outer edge part of the separator 10 extending in the right and left directions. Thus, the bolts 1C are allowed to be arranged in the inside of the fuel cell stack 1 without affecting the positions of the sixth hole 12 and the seventh hole 13 serving as a configuration necessary for power generation.

### <Other Changes>

Employable configurations for the fuel cell stack and the separator of the present disclosure are not limited to that of the embodiment described above. For example, in the embodiment described above, a configuration has been employed that the cutout part 2 is formed in each of the longer sides along the right and left directions of the end plate 1B, the separator 10, the collecting electrode plate 20, and the gasket 30. Instead, a configuration may be employed that the cutout part 2 is formed only in any one of the longer sides.

Further, the separator 10 and the collecting electrode plate 20 need not have exactly the same shape. For example, the depth D (see FIG. 4) of the cutout part 2 of the collecting electrode plate 20 may have a dimension difference of ±10% or the like relative to the depth D of the cutout part 2 of the separator 10.

In addition, in the embodiment described above, the cutout part 2 has been formed by cutting out the separator 10 into a trapezoidal shape whose upper base and lower base have mutually different lengths. However, the cutout part 2 may be formed by cutting out the separator 10 into a diverse shape other than the trapezoid. Further, the fuel cell stack and the separator according to the present disclosure may be applied widely to an air cooling type in addition to the water cooling type described above in the embodiment.

As this description may be embodied in several forms without departing from the spirit of essential characteristics thereof, the present embodiment is therefore illustrative and not restrictive, since the scope is defined by the appended claims rather than by the description preceding them, and all changes that fall within metes and bounds of the claims, or equivalence of such metes and bounds thereof are therefore intended to be embraced by the claims.

What is claimed is:

1. A fuel cell stack comprising:
a membrane electrode assembly of planar shape;
a separator of planar shape provided in one surface of the membrane electrode assembly, the separator comprising:
a plurality of grooves formed in a first surface of the separator and extending along a first direction parallel to the first surface, the first surface being one surface of the separator facing the membrane electrode assembly;
a protrusion formed in the first surface and enclosing a first hole, a second hole, and the plurality of grooves, the first hole being formed between one outer edge part of the separator along the first direction and the plurality of grooves, the second hole being formed between the one outer edge part of the separator and the plurality of grooves and being separated from the first hole in the first direction; and
a cutout part located between two third holes and formed by the one outer edge part of the separator approaching the protrusion and the plurality of grooves in a second direction perpendicular to the first direction and parallel to the first surface, the two third holes being adjacent to each other and being formed between the first hole and the second hole in the first direction and between the protrusion plus the plurality of grooves and the one outer edge part of the separator in the second direction; and
a collecting electrode plate in which a through hole is formed at a position corresponding to each of the first hole, the second hole, and the two third holes, the collecting electrode plate comprising:
a cutout part formed at a position corresponding to the cutout part of the separator; and
a terminal part extending from the cutout part of the collecting electrode plate toward the second direction.

2. The fuel cell stack according to claim 1, wherein the cutout part of the separator is formed between the two third holes adjacent to each other on both sides of a center position in the first direction of the separator.

3. The fuel cell stack according to claim 1, wherein:
the separator further defines a fourth hole and a fifth hole, the fourth hole being located between the protrusion enclosing the first hole and the outer edge part of the separator in the first direction and on a side opposite to the third holes relative to the first hole in the first direction, and the fifth hole being located between the protrusion enclosing the second hole and the outer edge part of the separator in the first direction and on a side opposite to the third holes relative to the second hole in the first direction; and
the collecting electrode plate further defines through holes respectively at positions corresponding to the fourth hole and the fifth hole.

4. The fuel cell stack according to claim 3, wherein:
the separator further defines a sixth hole and a seventh hole, the sixth hole being located between the plurality of grooves and one end in the first direction of the separator, and the seventh hole being located between the plurality of grooves and the other end in the first direction of the separator;
the collecting electrode plate is further provided with through holes respectively formed at positions corresponding to the sixth hole and the seventh hole;
the protrusion further encloses the sixth hole and the seventh hole;
the fourth hole is located between the sixth hole plus the protrusion and the one outer edge part of the separator in the second direction; and
the fifth hole is located between the seventh hole plus the protrusion and the one outer edge part of the separator in the second direction.

5. The fuel cell stack according to claim 1, wherein:
a distance in the first direction of the cutout part of the separator becomes large as departing from the plurality of grooves; and
a first distance that is the maximum distance in the first direction of the cutout part of the separator is larger than a distance between the two third holes in the first direction.

6. The fuel cell stack according to claim 5, wherein the first distance is 60 to 80 mm.

7. The fuel cell stack according to claim 1, wherein a length in the second direction of the cutout part of the separator is 17 mm or larger.

8. The fuel cell stack according to claim 1, wherein a center position in the first direction of the terminal part is offset relative to the center position in the first direction of the separator.

9. A separator of planar shape comprising:
a plurality of grooves formed in a first surface of the separator and extending along a first direction parallel to the first surface, the first surface being one surface of the separator facing a membrane electrode assembly;
a protrusion formed in the first surface and enclosing a first hole, a second hole, and the plurality of grooves, the first hole being formed between one outer edge part of the separator along the first direction and the plurality of grooves, the second hole being formed between the one outer edge part of the separator and the plurality of grooves and being separated from the first hole in the first direction; and
a cutout part formed between two third holes and formed by the one outer edge part of the separator approaching the protrusion and the plurality of grooves in a second direction perpendicular to the first direction and parallel to the first surface, the two third holes being adjacent to each other and being formed between the first hole and the second hole in the first direction and between the protrusion plus the plurality of grooves and the one outer edge part of the separator in the second direction.
